(19) United States
(12) Patent Application Publication
(10) Pub. No.: US 2013/0317655 A1
(43) Pub. Date: Nov. 28, 2013

(54) PROGRAMMABLE ENVIRONMENTAL CONTROL INCLUDING AN ENERGY TRACKING SYSTEM

(71) Applicant: Rajendra K. Shah, Indianapolis, IN (US)

(72) Inventor: Rajendra K. Shah, Indianapolis, IN (US)

(21) Appl. No.: 13/990,458

(22) PCT Filed: Feb. 8, 2012
(86) PCT No.: PCT/US12/24281

§ 371 Date: May 30, 2013

Related U.S. Application Data
(60) Provisional application No. 61/442,516, filed on Feb. 14, 2011.

(51) Int. Cl. G05B 13/02

(52) U.S. Cl. CPC G05B 13/02
USPC 700/276; 700/286

(57) ABSTRACT

A programmable control unit including a system control unit configured and disposed to receive an energy characteristic from at least one environmental control device. The system control unit determines energy usage data based on the energy characteristic pertaining to operation of the at least one environmental control device. An output device is operatively connected to the system control unit. The output device is configured and disposed to communicate the energy usage data to a user.

### CROSS REFERENCE TO RELATED APPLICATIONS

This application is a National Stage Application of PCT Application No. PCT/US12/024281 filed Feb. 8, 2012, which is a PCT Application of U.S. Provisional Patent Application No. 61/442,516 filed Feb. 14, 2011, the disclosures of which are incorporated by reference herein in their entireties.

### BACKGROUND OF THE INVENTION

Exemplary embodiments pertain to the art of environmental controls and, more particularly, to a programmable environmental control including an energy tracking system.

Environmental controls have evolved over time from simple temperature based controls to more conventional programmable controls. Programmable controls allow users to set a particular temperature in an environmental control zone for a particular time of day. More specifically, programmable controls or thermostats enable users to program a schedule of temperature set points for a fixed number of control phases over the course of a day. In some cases, a different schedule may be programmed for different days. In many cases, one of the control phases is designated to span a time period when the environmental control zone is unoccupied.

As there is no need to maintain a comfortable temperature when the environmental control zone is unoccupied, many users program a lower temperature (for heating) or a higher temperature (for cooling) for the environmental control zone during unoccupied periods. Depending on the lowered temperature or degree of set back, a user can save on heating/cooling costs. Unfortunately, many users will set too great or too little of a set back. Too great a set back leads to a prolonged recovery time which, in turn leads to the environmental control zone not returning to the comfortable temperature at a desired time and inefficient operation of heating/air conditioning systems. Too low of a set-back temperature leads to lost energy savings as greater savings could potentially be realized with a higher set back. As such, many users do not see any benefit to establishing a set back temperature. Most existing systems do not provide any useful feedback that allows a user to track energy usage. Systems that do provide feedback are costly, often requiring that multiple meters, sensors or other external devices to be connected to the system being monitored as well as requiring sensors to be connected to each energy meter that monitors supplied energy.

### BRIEF DESCRIPTION OF THE INVENTION

Disclosed is a programmable control unit including a system control unit configured and disposed to receive at least one energy characteristic from at least one environmental control device. The system control unit determines energy usage data based on the at least one energy characteristic pertaining to operation of the at least one environmental control device. An output device is operatively connected to the system control unit. The output device is configured and disposed to present the energy usage data to a user.

Also disclosed is an environmental control system including at least one environmental control device having at least one energy characteristic, and a programmable environmental control unit operatively coupled to the at least one environmental control device. The programmable environment control includes a system control unit configured and disposed to receive the at least one energy characteristic from the at least one environmental control device. The system control unit determines energy usage data based on the at least one energy characteristic pertaining to operation of the at least one environmental control device. An output device is operatively connected to the system control unit. The output device is configured and disposed to communicate the energy usage data to a user.

Still further disclosed is a method of monitoring energy usage for an environmental control system. The method includes receiving at least one energy characteristic from an environmental control device, sensing an operating mode of the environmental control device, determining energy usage data for the environmental control device based on the at least one energy characteristic and the operating mode, and outputting the energy usage data.

### BRIEF DESCRIPTION OF THE DRAWINGS

The following descriptions should not be considered limiting in any way. With reference to the accompanying drawings, like elements are numbered alike:

FIG. 1 is a schematic diagram illustrating an environmental control system in accordance with an exemplary embodiment; and

FIG. 2 is a flow chart illustrating a method of tracking energy usage of the environmental control system of FIG. 1.

### DETAILED DESCRIPTION OF THE INVENTION

A detailed description of one or more embodiments of the disclosed apparatus and method are presented herein by way of exemplification and not limitation with reference to the Figures.

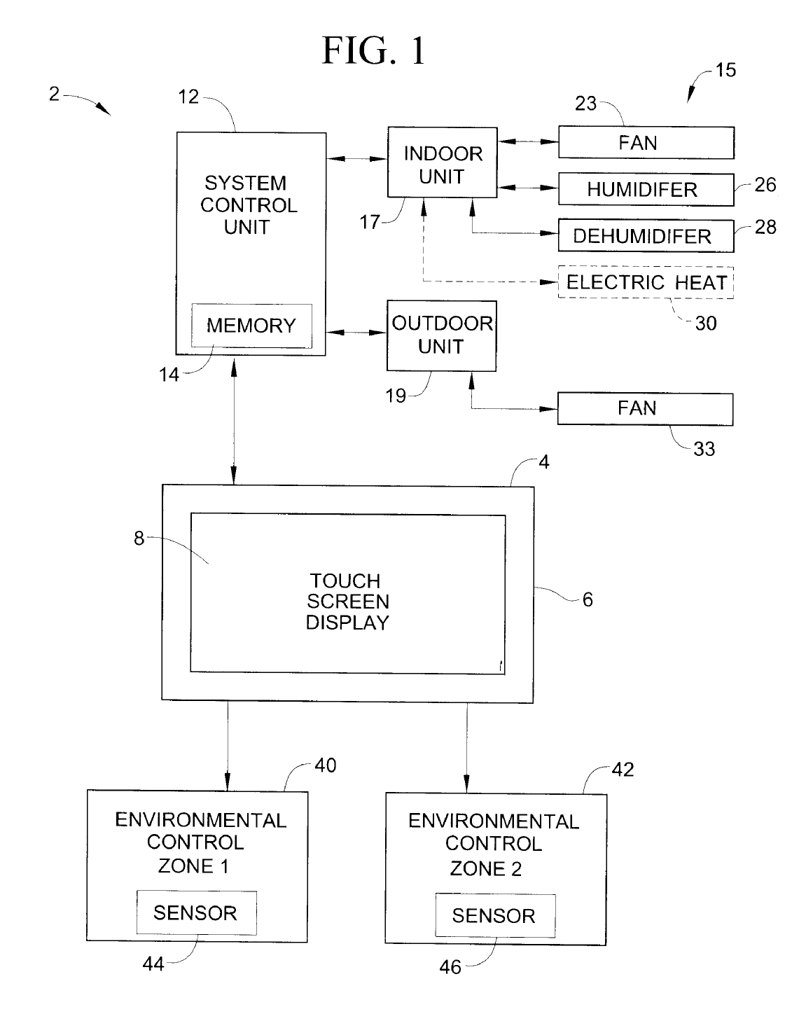

With reference to FIG. 1 an environmental control system in accordance with an exemplary embodiment is indicated generally at 2. Environmental control system 2 includes a programmable control unit 4 having a housing 6 and a user input/output device shown in the form of a touch screen display 8 that allows a user to establish and view various environmental control parameters or conditions for one or more environmental control zones as will be detailed more fully below. Programmable control unit 4 also includes a system control unit 12 having a memory. Programmable control unit 4 is operatively connected a plurality of environmental control devices 15. At this point it should be understood that while shown with touch screen display 8, programmable control unit 4 can be provided with other mechanisms that accept user input such as buttons or key pads in combination with a liquid crystal display (LCD) screen that displays current and desired temperature information. Also, while shown with an integrated controller, programmable control unit 4 can be operatively connected to a controller located remote from housing 6.

In the exemplary embodiment shown, environmental control devices 15 include an indoor unit 17, such as a gas furnace, electric heater or the like, and an outdoor unit 19 such as an air conditioner unit, heat pump and the like. The particular type of indoor and outdoor units 17 and 19 can vary. Environmental control devices 15 also include a fan 23, a humidifier 26, and a dehumidifier 28 operatively connected to indoor unit 17. When outdoor unit 19 takes the form of a heat pump, environmental control devices 15 may also include an electric heating coil unit 30 operatively coupled to indoor unit 17. Finally, environmental control devices 15 are also shown to include a fan 33 associated with outdoor unit 19. At this point it should be understood that the particular form and number of environmental control devices can vary. Environmental control devices 15 are configured to condition first and second environmental control zones 40 and 42 each having an associated sensor 44 and 46. Environmental control devices 15 may be arranged to condition environmental control zone 40 and 42 independently or provide similar environmental conditions for zones 40 and 42 depending upon installation type.

In accordance with the exemplary embodiment, each of the plurality of environmental control devices includes one or more energy characteristics specific to each device. The energy characteristic(s) can include information associated with device type, number of stages, device capacity, and device efficiency. As noted above, the type of device can include gas furnaces having a furnace coil, a fan coil, an electric heater, and air conditioning unit and/or a heat pump. Environmental control devices may also include a multi-zone unit that is configured to independently condition environmental control zones 40 and 42, and a fresh air ventilator and the like. In accordance with one aspect of the exemplary embodiment, each of the plurality of environmental control devices 15 is configured to communicate the energy characteristic to programmable control unit 4 to be stored in memory 14. In accordance with another aspect of the exemplary embodiment, the energy characteristic(s) can be entered into programmable control unit 4 either directly through tough screen display 8 or through other communication protocols. Regardless of how the energy characteristic is entered, system control unit 12 monitors and tracks energy usage of each of the plurality of environmental control devices 17 as will be discussed more fully below.

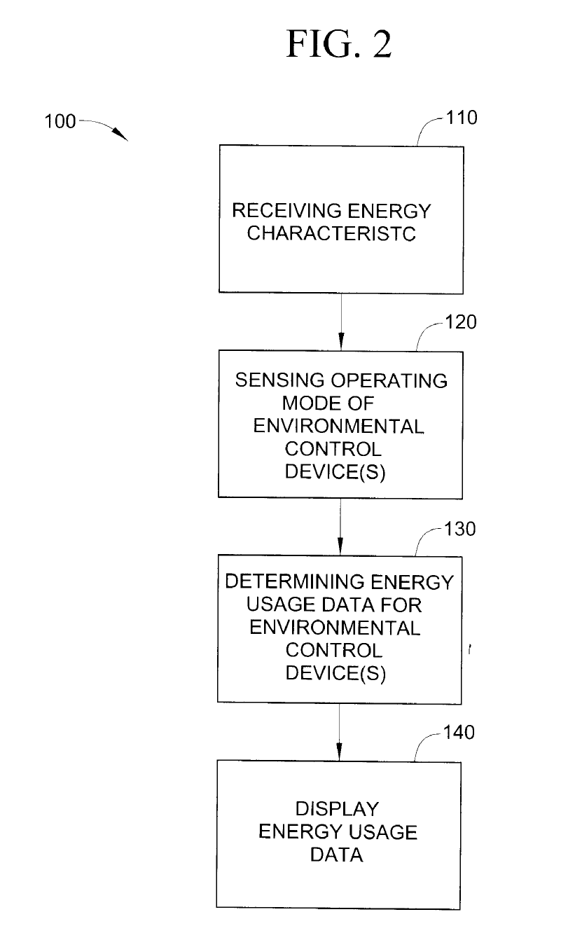

Reference will now be made to FIG. 2 in describing a method 100 of tracking energy usage from plurality of environmental control devices 15 in accordance with an exemplary embodiment. As discussed above, an energy characteristic associated with each environmental control device 15 is received by programmable control unit 4 as indicated by block 110. After the energy characteristic is received, system control unit 10 senses an operating mode of each of the plurality of environmental control devices 15 coupled to programmable control unit 4 as indicated in block 120. During operation of each environmental control device 15, system control unit 10 determines energy usage rate or data as indicated in block 130. Energy usage data is determined based on the stored energy characteristic, and operational mode of the one or more environmental control devices 15.

System control unit 10 determines energy usage data for cooling, heating and humidification/dehumidification. For example, during a heating mode using a gas furnace, system control unit 10 determines gas usage, and electrical usage for any active fans, humidifiers and the like. During a heating mode using a heat pump, system control unit 10 will determine electrical usage for the heat pump, as well any humidifier, and/or electric heat coil in operation. Similarly, for an air conditioning mode, system control unit will determine energy usage for a compressor, as well as any fans, and/or dehumidifier that may be in operation. The energy usage data is then communicated to an output device such as touch screen display 8 as indicated in block 140. Of course it should be understood that the energy usage data could also be communicated to other devices both directly and wirelessly connected to programmable control unit 4. The energy usage data can be presented as text, or graphics including bar graphs, and pie charts. The energy usage data can also be presented as current energy usage, that is, energy being used for a particular day, as well as energy usage history for a particular time period(s) such as weeks, months, years etc. In addition, programmable control unit 4 can be set to provide a comparison between energy used for selected time periods. In addition, energy usage data can be presented in energy units such as British thermal units (BTU) or kilowatt/hour (kWH) and/or in monetary units based on current utility rates.

At this point it should be understood that programmable control unit 4 determines and tracks energy usage for any connected environmental control devices without the need for individual meters, sensing devices, or other external devices and the like. More specifically, receiving the energy characteristic either by direct communication or programming enables programmable control unit to monitor and track energy usage, including gas and electric usage of one or more operating environmental control devices. It should also be understood that the number, type, and manufacture of the environmental control device can vary.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims.

What is claimed is:

1. A programmable control unit comprising:
a system control unit configured and disposed to receive an energy characteristic from at least one environmental control device, the system control unit determining energy usage data based on the energy characteristic pertaining to operation of the at least one environmental control device; and
an output device operatively connected to the system control unit, the output device being configured and disposed to communicate the energy usage data to a user.

2. The programmable control unit according to claim 1, wherein the system control unit is configured and disposed to determine at least one of electrical energy usage and gas energy usage of the at least one environmental control device.

3. The programmable control unit according to claim 1, wherein the system control unit is configured and disposed to communicate directly with the at least one environmental control device.

4. The programmable control unit of claim 1, wherein the energy characteristic is one of a device type, number of stages for a device, device capacity, and device efficiency.

5. The programmable control unit of claim 1, wherein the output device comprises a display.

6. The programmable control unit of claim 5, wherein the display comprises a touch screen display.

7. The programmable control unit of claim 1, wherein the output device communicates the energy usage data as at least one of an energy rate and as a monetary unit.

8. An environmental control system comprising:
at least one environmental control device having an energy characteristic;
a programmable control unit operatively coupled to the at least one environmental control device, the programmable environment control unit comprising:
a system control unit configured and disposed to receive the energy characteristic from the at least one environmental control device, the system control unit determining energy usage data based on the energy characteristic pertaining to operation of the at least one environmental control device; and
an output device operatively connected to the system control unit, the output device being configured and disposed to communicate the energy usage data to a user.

9. The environmental control system according to claim 8, wherein the system control unit is configured and disposed to determine at least one of electrical energy usage and gas energy usage of the at least one environmental control device.

10. The environmental control system according to claim 8, wherein the system control unit communicates directly with the at least one environmental control device.

11. The environmental control system according to claim 8, wherein the at least one environmental control device comprises a plurality of environmental control devices.

12. The environmental control system according to claim 11, wherein the plurality of environmental control devices includes gas operated environmental control devices and electrically operated environmental control devices.

13. The environmental control system according to claim 11, wherein the system control unit determines energy usage data for each of the plurality of environmental control devices.

14. The environmental control system according to claim 8, wherein the system control unit detects an operating condition of the at least one environmental control device.

15. The environmental control system according to claim 8, wherein the energy characteristic is one of a device type, number of stages for a device, device capacity, and device efficiency.

16. The environmental control system according to claim 8, wherein the output device comprises a display.

17. The environmental control unit according to claim 16, wherein the display comprises a touch screen display.

18. The environmental control system of claim 8, wherein the output device communicates the energy usage data as at least one of an energy rate and as a monetary unit.

19. A method of monitoring energy usage for an environmental control system, the method comprising:
receiving an energy characteristic from an environmental control device;
sensing an operating mode of the environmental control device;
determining energy usage data for the environmental control device based on the energy characteristic and the operating mode; and
outputting the energy usage data.

20. The method of claim 19, wherein sensing an operational mode of the environmental control device includes detecting operating time of the environmental control device.

21. The method of claim 19, wherein receiving the energy characteristic from the environmental control device includes receiving an energy characteristic from each of a plurality of environmental control devices.

22. The method of claim 21, wherein sensing the operational mode of the environmental control device includes sensing an operational mode of each of the plurality of environmental control devices.

23. The method of claim 22, wherein determining energy usage data for the environmental control device includes determining energy usage data for each of the environmental control devices.

24. The method of claim 23, wherein determining energy usage data for each of the environmental control devices includes determining gas energy usage data and electric energy usage data.

25. The method of claim 19, wherein an energy characteristic from an environmental control device includes receiving one of a device type, number of stages for a device, device capacity, and device efficiency.

26. The method of claim 19, wherein determining energy usage data for the environmental control device includes tracking energy usage data for the environmental control device for a first time period, and tracking energy usage data for a second time period.

27. The method of claim 19, wherein outputting the energy usage data comprises transmitting the energy usage data to a display.

28. The method of claim 19, wherein outputting the energy usage data comprises outputting the energy usage data in at least one of an energy rate and a monetary value.
